(19) United States
(12) Patent Application Publication
(10) Pub. No.: US 2008/0318183 A1
(43) Pub. Date: Dec. 25, 2008

(54) Bite block with snap-in positionable fluid ejector

(76) Inventor: Colin Suzman, Irvine, CA (US)

Correspondence Address: PATENT LAW & VENTURE GROUP, 2424 S.E. BRISTOL, SUITE 300, NEWPORT BEACH, CA, 92660, US

(21) Appl. No.: 11/821,445

(22) Filed: Jun. 23, 2007

(51) Int. Cl. A61C 17/10

(52) U.S. Cl. 433/93

(57) ABSTRACT

A dental appliance apparatus is made up of a bite block and a snap-in, positionable fluid ejector. An aspirator tube is positioned and slideably engaged within a tube holder which, in turn, is rotatably engaged with the bite block. This allows for selective angular positioning of the aspirator tube so as to accommodate a wide range of patients in aspirating fluids as efficiently as possible.

### BACKGROUND OF THE INVENTION

1. Field of the Present Disclosure

This disclosure relates generally to dental appliances and, more particularly, to a bite block with a snap-in, positionable fluid ejector.

2. Description of Related Art Including Information Disclosed Under 37 CFR 1.97 and 1.98

Lowry, U.S. Pat. No. 1,986,275 discloses a combination anterior mouth support and saliva ejector having a hose connection capable of being changed from the right or left side of the mouth of the jaw brace whereby the jaw brace may be interchangeably positioned relative to the hose connection. In addition, the device has absorbent cotton holders for collecting undue moisture or saliva present in the patient's mouth.

Smith, U.S. Pat. No. 3,483,619 discloses a dental rest for patients' jaws to comfortably receive them in an open bite position, comprising three structural supports all arranged on a planar body and radially spaced out from the body center and also circumferentially spaced from each other so one structural support will contact principally one tooth in one jaw and two structural supports will contact respective teeth in the other jaw. Further, this overall dental rest is pliable enough to permit a dental patient to adjust his jaws a bit without dislodging the dental rest as dental work proceeds. This three structural support dental rest readily self adjusts to the respective different arcuate motions of the upper and lower jaws.

Schubert, U.S. Pat. No. 4,167,814 discloses a combination mouth prop and oral evacuation device for use by a dentist including a mouth prop for fitting between the upper and lower jaws for holding the mouth open, an attached, generally U-shaped suction tube secured to the mouth prop and fitted inside the lower jaw below the tongue and inside the teeth, for drawing fluids from within the mouth during dental work therein, and a tongue guard on the suction tube.

Dyfvermark, U.S. Pat. No. 4,975,057 discloses a dental appliance in the form of a bite block for use during dental surgical operations. At least one aperture is integrally formed in the bite block serving as an evacuation nozzle for a combined saliva and filling debris aspirator. In one of these apertures is inserted a suction nozzle associated with an aspiration device. This bite block thus is the only extra instrument that the dentist needs to place in the oral cavity of the patient in addition to his working tools.

Osborn, U.S. Pat. No. 5,009,595 discloses an improved mouth prop for dental patients in the form of a tapered block made of pliable styrene material. A portion of one side of the block is concave so as to more readily provide access to the patient's mouth and improve visibility. The block includes a pair of flanges extending from the top and bottom thereof on the cheek side to aid in stabilizing the block and to keep soft tissue away from the working area of the mouth and to channel saliva away from the working area.

Duggan et al, U.S. Pat. No. 5,152,686 discloses a dental appliance which includes a bite block made of formable material which includes a tongue stabilizer and a suction tube slideably and removably secured in the bite block for removing debris from the mouth cavity. The appliance may include a raised area for securing the appliance with the patient's teeth during performance of the dental procedures and a posterior vein located in the sidewall of the bite block with an aperture placed in the posterior vein for the suctioning of debris and saliva from the soft palate region of the mouth cavity behind the bite block. A slideably and removably secured rod for transmitting a fiber optic light source for illumination of at least a portion of the mouth cavity may also be included.

Clementz, U.S. Pat. No. 5,407,353 discloses an extractor for extracting by suction; dust and vapor generated during dental treatment. The device includes a hood-like member which is intended to be placed over the patient's teeth, and a suction device having a suction nozzle located within the hood-like member. The hood-like member has a part which faces towards the free ends of the teeth and which is provided with an opening through which dental work can be carried out. The hood-like member is made from a readily-shapeable and/or resilient material. Bendable inserts can be placed in or on the walls of the hood-like member, on opposite sides of the opening. The part of the suction device located nearest the hood-like member includes a handle by means of which the hood-like member can be placed over and held in position on the patient's teeth.

Landis et al, U.S. Pat. No. 5,588,836 discloses a mouth prop and tongue retractor apparatus for use in dental procedures. The apparatus includes a handle rotatably mounted within a base. A ball joint on the base fits within a socket in a mouth prop to provide pivotal positional adjustment of the apparatus. An elongated aspirator tube extends through the handle and base, and is coupled to a tongue retractor. A suction aperture on the tongue retractor communicates with the aspirator tube and provides for saliva removal from a patient's mouth. Rotation of the handle provides extension adjustment for the aspirator tube and tongue retractor.

Eldreth, U.S. Pat. No. 5,769,635 discloses a dental appliance including a circular ring member and two laterally extending rigid arm members which have bite pads on the ends thereof. The circular ring member includes an opening therethrough sized to slideably mount a saliva ejector. The arm members and the ring member are dimensioned to minimize the obstruction of the field of view of the mouth of a dental professional.

Eldreth, U.S. Pat. No. 5,924,866 discloses a dental appliance made up of an elongated body having a substantially longitudinal axis with opposite end portions making up substantially flat surfaces extending lateral to the axis for being engaged by teeth or endentulous areas of the upper and lower jaws of a patient. A circular opening is provided within this middle region of the elongated body to allow the tube of a saliva and debris ejector to be positioned slideably therein, and within the mouth of a patient when the apparatus is being used. The elongated body is narrower between the flat surfaces of the bite pads for maximizing the visual field of a mouth to the person performing a dental procedure. The elongated body is deformable to ensure stable engagement between the teeth or endentulous region of the upper and lower jaws of a patient and the corresponding flat surface making up the bite pads of the elongated body.

Hirsch et al, U.S. Pat. No. 6,022,214 discloses an intraoral illumination device and method for illuminating the interior cavity of a patient's mouth during a medical procedure. The illumination device includes a bite block adapted to be engaged by a patient's teeth for resting the patient's jaw during the medical procedure and fixing the bite block within the patient's mouth. An arcuate light dispersion piece is connected to the bite block so that, in use, the light dispersion piece is orientated in a rear, central part of the oral cavity of the patient's mouth so that dispersed light can be transmitted outward from the rear, central part of the oral cavity. A tongue and cheek retractor is adapted to retract and protect the patient's tongue and adjacent cheek tissue during the medical procedure. Multiple fluid evacuation channels are carried by the device and are adapted to communicate with the interior cavity of the patient's mouth for removing fluids from the oral cavity during the medical procedure.

Pancallo, U.S. Pat. No. 6,193,513 discloses a dental device acting as a variable-height mouth opener, a saliva ejector and an oral dam including a casing having a shape reproducing the shape of the dental arches and able to maintain the patient's mouth open once inserted into it in contact with the dental arches, and a saliva discharge opening communicating with a tube for removing the saliva by suction applied to the other end of the tube. The size of the device casing in the mastication direction can be varied from a minimum to a maximum, for example, by pivotally mounting a projecting element to the casing.

Garrison, U.S. Pat. No. 6,241,521 discloses a bite block for facilitating a dentist's access to a patient's mouth, which includes an open-ended, U-shaped body having a pair of arms extending from a bite portion, thereby defining a void that is bounded in part by the arms and the bite portion, whereby when the bite block is positioned between upper and lower teeth of the patient's mouth the dentist will have access to the patient's mouth through the void.

Campbell, U.S. Pat. No. 6,244,866 discloses a dental apparatus for maintaining the mouth of a patient in an open position during a dental procedure. The apparatus has a bite block that is inserted into the patient's mouth between the upper and lower molars on either side of a patient's mouth. Disposed in operable relation to the bite block is a tongue suppressor for retaining the tongue of a patient in the bottom cavity of the mouth. The tongue suppressor has a retaining arm that extends across the tongue away from the bite block. Opposite the bite block on the retaining arm is a flange that extends downward toward the bottom of the mouth. The retaining arm and the flange retain the patient's tongue in the bottom cavity of the patient's mouth.

Barstow, U.S. Pat. No. 6,267,591 discloses a dental device that includes a tongue-retracting surface and a throat dam adapted to be positioned in the mouth of a patient. Integral lip-retracting surfaces and a grip portion are connected to the tongue-retracting surface and throat dam by a prop portion which preferably has angled biting surfaces adapted to be engaged by the teeth of the patient. An expandable throat barrier net may be attached to a portion of the throat dam. An evacuation system may be provided to remove fluids from the mouth. The biting surfaces may be provided with a pad or a thermoplastic material for the comfort of the patient. A reflective material may be attached to the tongue-retracting surface and a fiber optic rod may be carried by the tongue-retracting surface to assist in illuminating the oral cavity of the patient.

Fischer, U.S. Pat. No. 6,655,960 discloses a dental apparatus for maintaining the mouth of a patient in an open position during a dental procedure. The apparatus includes a bite block that is inserted into the patient's mouth between the upper and lower teeth on either side of a patient's mouth. Disposed in operable relation to the bite block is a tongue suppressor for confinement of the patient's tongue within a desired location, such as the bottom cavity, of the patient's mouth. The tongue suppressor includes a retention arm that extends across the tongue laterally away from the bite block. The bite block includes features, such as a plurality of slots or paired recesses, that allow for a portion of the tongue suppressor, such as the retention arm, retention prongs or an adjustment peg to be selectively inserted and retracted relative to the bite block to provide for lateral adjustment of the tongue suppressor relative to the bite block. In addition, the tongue suppressor can be moved vertically relative to the bite block to account for the tremendous variation between the sizes and shapes of different patient's mouths, teeth, tongues and the like.

Fischer et al, U.S. Pat. No. 6,716,029 discloses a bite block system for maintaining the mouth of the patient in an open position during a dental procedure. In one embodiment, the bite block includes a plastically deformable material on at least a surface thereof for making an impression of the patient's teeth. Such customized bite blocks provide greater safety and comfort. In another aspect, a tongue suppressing bite block system includes a bite block and a tongue suppressor adjustably attached thereto so that the tongue depressor can be adjusted horizontally or vertically relative to the bite block to account for variations in the size of patient's mouths, teeth and tongues. In another aspect of the invention, an anatomical tongue depressor is provided for use with a bite block. The anatomical tongue depressor wraps around the side and underneath the tongue in order to cradle it in a more comfortable and secure fashion when in use with the bite block. The anatomical tongue suppressor may optionally include a saliva aspiration port that permits the aspiration of saliva through one or more lumens within the tongue suppressor.

Hirsch et al, U.S. Pat. No. 6,974,321 discloses an intraoral device that includes a one-piece, flexible, injection molded body made of a single homogeneous material. The body includes upper front and rear flaps, and lower front and rear flaps. Upper edges of the front flaps and lower edges of the lower flaps are sealed by respective upper and lower parts of a patient's mouth to form upper and lower evacuation channels when the body is disposed within the patient's mouth. Evacuation holes in the flaps are in communication with the evacuation channels. A connection section is in communication with the evacuation channels and is configured to extend outside of the patient's mouth to connect with a vacuum source for evacuating fluid from the patient's mouth through the evacuation holes and the evacuation channels.

Jensen et al, US 2006/0110705 discloses a dental block that is V-shaped. The V-shape provides accessibility to working instruments while in a patient's mouth. Current bite blocks are often shaped as solid triangles that are designed to keep the mouth open. A bite block is usually placed by dentists in the side opposite their work area. This provides an open work area for the dentist on one side, but restricts access by dental assistants on the other. The device provides an open V-shaped design that is accessible to dental instruments while maintaining the patient's mouth open.

The related art described above discloses use of bite blocks alone, as well as bite blocks in combination with specially designed fluid ejectors. However, the prior art fails to disclose a bite block that accommodates the type of aspirator tube commonly used in dentistry. In addition, the prior art fails to teach a bite block that has a snap-in ejector housing which allows the aspirator tube to be adjusted selectively over a range of angles. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

In dentistry, it is common practice to use an aspirator tube for removing fluids within a patient's mouth during a dental procedure. The prior art teaches the use of bite blocks for holding the mouth in an open attitude, as well as the use of a bite block to secure an aspiration tube in a desired position and attitude. However, due to the fact that mouth geometry varies widely, optimal placement of aspirator tubes varies between individuals. The prior art bite block/aspirator tube combinations allow for only a single position of the aspirator tube within the mouth. In contrast, the present apparatus provides a tube holder that is rotatably engaged with a bite block, enabling selective angular positioning of the aspirator tube so as to accommodate a wide range of mouth sizes and geometries in order to optimize the aspiration process.

In addition, prior art bite block and aspirator tube combinations typically use specially designed aspirator tubes to fit a particular bite block; thus requiring dentists to buy specialty aspirator tubes. The presently described apparatus solves this problem by accommodating common, widely used tubes.

A primary objective inherent in the above described apparatus and method of use is to provide advantages not taught by the prior art.

Another objective is to provide a bite block and aspirator tube combination that allows for selective angular positioning of the aspirator tube relative to the bite block.

A further objective is to provide a bite block that accommodates the type of aspirator tube commonly used in dentistry

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIGS. 1 and 2 are perspective views of the presently described apparatus with an aspirator tube slideably engaged within a tube holder;

FIG. 3 is a cross-sectional view of the bite block portion of the apparatus; and

FIG. 4 is a perspective view of the tube holder portion of the apparatus.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

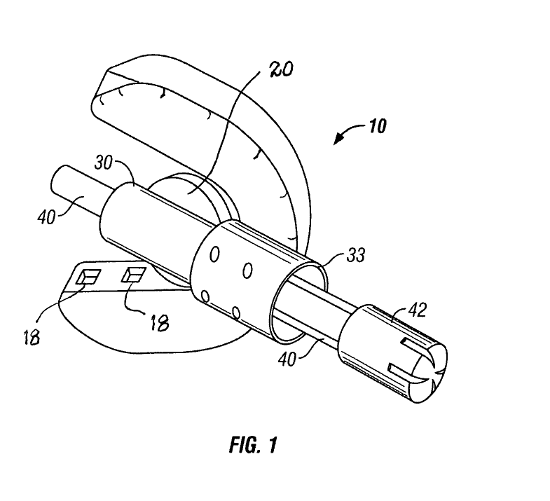

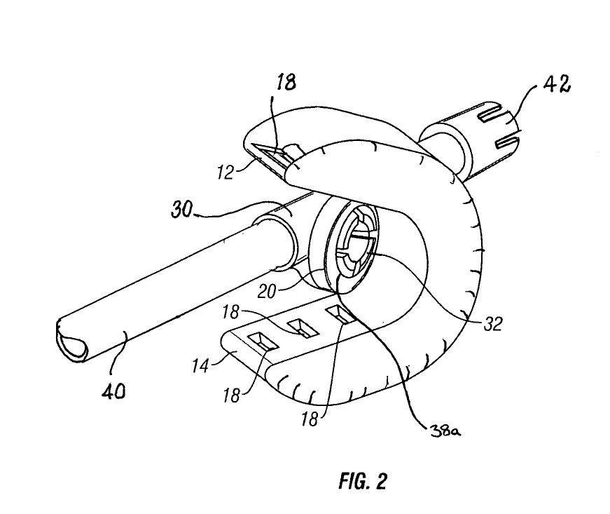

Described now in detail is a dental appliance apparatus with a snap-in, positionable fluid ejector. The present invention comprises a bite block 10 providing teeth engaging ramps 12 and 14, and an integral receiver 20. A tube holder 30 is rotatably engaged with the receiver 20, enabling selective angular positioning of the tube holder 30 relative to the bite block 10. An aspirator tube 40 is positioned and slideably engaged within the tube holder 30, as shown in FIGS. 1 and 2.

The bite block 10 is preferably U-shaped as shown in FIGS. 1 and 2, and is preferably fabricated from a ninety-durometer urethane or similar polymeric material commonly used in dentistry, which is rigid and yet yielding enough so that it can comfortably be grasped between a patient's teeth for periods of time necessary for dental procedures. The ramps 12 and 14 may include a textured surface which is adapted for aiding traction on the bite block 10 by the upper and lower teeth of a patient. Additionally, in the preferred embodiment, each of the ramps 12 and 14 provides a plurality of openings 18. Each one of the openings 18 is preferably rectangular in shape and spaced linearly apart to accept the crowns of a patient's tooth when the patient bites down on the bite block 10. Thus, each one of the openings 18 serves two purposes: it aids traction on the bite block and it prevents fluid buildup within the U-shaped cross section of the bite block by allowing fluids to pass through. It should be noted that other shapes and spacing arrangements of openings 18 may be substituted without loss of efficacy.

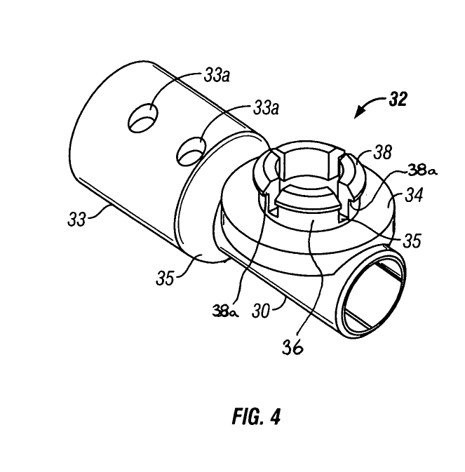

The tube holder 30, shown in detail in FIG. 4, is preferably made of a rigid, injection-molded plastic material. However, other materials known to persons of ordinary skill in the art may be substituted. Tube holder 30 is constructed with a proximal portion collinear with a larger diameter distal portion, the latter referred to herein as an aspirator shield 33. The purpose of the aspirator shield 33 is to provide protection for the aspirator tube 40, limiting contact of the patient's tongue, as well as dental tools, from interfering with the tube's preferred suction position. In the preferred embodiment, the aspirator shield 33 has a plurality of holes 33a along its surface which allow fluids to freely pass through, thus facilitating the ejection of fluids from the patient's mouth.

As previously stated, the type of aspirator tube 40 used in conjuction with the present apparatus is common in the field of dentistry. Thus dentists are able to use the present apparatus without having to purchase specialty aspirator tubes. The aspirator tube 40 itself is typically a length of flexible tubing, with a slotted end cap 42 frictionally mounted on the end of the tube 40 in a compressed force fit. When the aspirator tube 40 is inserted through the aspirator shield 33, it is frictionally engaged within the proximal portion of tube holder 30. The contact between the aspirator tube 40 and holder 30 is free enough so as to allow the dentist to manually adjust the length of tube 40 protruding from the end of shield 33. At the same time, the contact is rigid enough so as to maintain the tube's position should the patient's tongue tend to interfere with it.

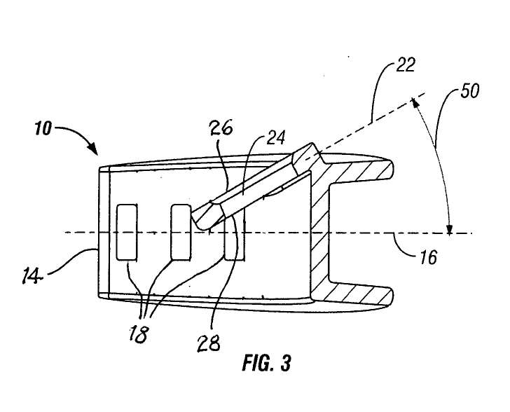

As shown in FIG. 4, the tube holder 30 provides a fixture 32 which may be engaged with the receiver 20. As clearly shown in FIG. 2, receiver 20 is formed integrally with bite block 10 and positioned between ramps 12 and 14. It has two opposing side surfaces 26 and 28 (FIG. 3) and a central through hole 24. The fixture 32 is able to be snapped into and engaged compressively with hole 24 in the receiver. Fixture 32 provides a contact surface 34 which abuts surface 26, and an elastically flexible tubular engagement piece 36 extending from the contact surface 34. The engagement piece 36 terminates with an outwardly directed flange 38, which is spaced apart from the contact surface 34 so as to accept the receiver 20 in a compression fit. Preferably, the engagement piece 36 has two spaced apart, axially directed slots 35 enabling the engagement piece 36 to radially flex, allowing the flange 38 to pass through hole 24 in the receiver 20. When joined in this fashion, the engagement piece 36 snaps into the receiver 20, as shown in FIG. 2. Once the engagement piece 36 is snapped into place, the receiver 20 is held in compressed contact between the contact surface 34 and lips 38a of the flange 38. This contact permits the tube holder 30 to rotate while compressively maintaning its set position during dental operations.

Having the tube holder 30 rotatably engaged with the receiver 20 allows the dentist to freely adjust the vertical angular position of the tube holder 30 in order to find the best location to aspirate fluids as efficiently as possible. This location varies between individuals. As shown in FIG. 3, the bite block 10 defines a longitudinal axis 16 and the receiver 20 defines a receiver plane 22. When the bite block 10 is initially molded during manufacture, the receiver plane 22 is set at a fixed angle 50 relative to the longitudinal axis 16 of the bite block 10. The angle 50 is fixed between 0° and about 45° which range is appropriate for most individuals, allowing the end cap 42 to rest on the midline of the patient's mouth. In the preferred embodiment, the angle 50 is 30°, as this has been found to accommodate the widest range of patients. Angles 50 greater than 45° may also be used if deemed necessary for a particular patient.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A dental appliance apparatus comprising: a bite block providing teeth engaging surfaces, and an integral receiver; an aspirator tube; and a tube holder, the tube holder providing a fixture integral therewith, the fixture rotatably engaged with the receiver thereby enabling selective angular positioning of the tube holder; the aspirator tube slidably engaged within the tube holder and extensive therefrom.

2. The apparatus of claim 1, wherein the tube holder further provides an aspirator shield extensive coaxially about a portion of the aspirator tube.

3. The apparatus of claim 2 wherein the aspirator shield provides at least one hole therein for fluid flow therethrough.

4. The apparatus of claim 1 wherein the aspirator tube terminates with a frictionally mounted, slotted end cap.

5. The apparatus of claim 1 wherein the bite block defines a longitudinal axis and the receiver defines a receiver plane; wherein the receiver plane is set at an angle relative to the longitudinal axis of the bite block, the angle being between 0° and 45°.

6. The apparatus of claim 5 wherein the angle is approximately 30°.

7. The apparatus of claim 1 wherein at least one of the teeth engaging surfaces provides a plurality of openings therethrough.

8. The apparatus of claim 7 wherein the openings are each rectangular in shape and spaced linearly apart in correspondence with tooth spacing of a patient.

9. The apparatus of claim 1 wherein the fixture provides a contact surface and, extending from the contact surface, an elastically flexible tubular engagement piece.

10. The apparatus of claim 9 wherein the engagement piece terminates with an outwardly directed flange, the flange spaced apart from the contact surface so as to accept the receiver therebetween in a compression fit.

11. The apparatus of claim 10 wherein the tubular engagement piece has at least two spaced apart, axially directed, slots enabling the engagement piece to radially flex to pass through a hole in the receiver, whereby, the tube holder is engaged with the receiver and rotatable thereon.
